(19) United States
(12) Patent Application Publication
(10) Pub. No.: US 2025/0050987 A1
(43) Pub. Date: Feb. 13, 2025

(54) SHIP WITH AT LEAST ONE SAIL PROPULSION UNIT

(71) Applicants: OCEANWINGS, Paris (FR); MARVIN SERIES, Vannes (FR); ALWENA SHIPPING, Marseille (FR)

(72) Inventors: Katia MERLE, Vannes (FR); Nicolas BARAL, Vannes (FR); Simon WATIN, Vannes (FR); Francois-Xavier LOUIS, Marseille (FR); Ludovic GERARD, Marseille (FR)

(21) Appl. No.: 18/722,775

(22) PCT Filed: Dec. 23, 2022
(86) PCT No.: PCT/IB2022/062735

§ 371 Date: Jun. 21, 2024

(30) Foreign Application Priority Data
Dec. 23, 2021 (FR) 2114463

(51) Int. Cl. B63H 9/061

(52) U.S. Cl. CPC B63H 9/0635

(57) ABSTRACT

A ship comprises at least one sail propulsion unit (100) extending in a generally vertical direction in a position of use and comprising one or more propulsion elements (111, 112) and a mast (121). According to the invention, the structure of the ship intrinsically comprises transverse structural elements (T; 300) defining at least in part at least one respective cavity, while the ship comprises at least one sail propulsion unit (100) situated generally above a cavity. The ship additionally comprises a support (210) for the sail propulsion unit, the support being movable in a generally vertical direction within the cavity (CA), and drive means for selectively moving the support between a raised position of use and a retracted position of stowage.

### FIELD OF THE INVENTION

The present invention relates generally to sail propulsion for ships, particularly propulsion assistance for merchant ships.

### PRIOR ART

In particular, documents WO2018087649A1 and WO2020115717A1 describe a twin-wing propulsion unit which comprises a double airfoil mounted on a structure angularly controlled around a generally vertical axis depending on conditions, where the double airfoil comprises a fore flap and an aft flap, a fore mast and an aft mast connected by a boom member and a gaff member, the fore flap being traversed by the fore mast and rotatable about an axis defined thereby, and the aft flap being traversed by the aft mast and rotatable about an axis defined thereby.

The structure is capable of rotating on an axis of rotation coinciding with the axis of rotation of the fore mast.

Also known are rotor-based sail propulsion units (that is, of the Flettner rotor or suction rotor type), which are starting to equip merchant ships.

In the state of the art, there are a number of approaches to retracting sail propulsion systems during non-navigation phases.

Firstly, US2014144362A1 describes an approach where wings can be tipped into specifically designed receptacles, with these cavities oriented transversely to or parallel to the ship's main axis. In one variant, a wing can be stored in its specific receptacle by means of a translational movement.

This approach requires considerable modification of the ship's structure to accommodate the receptacles associated with the various sail propulsion units.

Document JPS57178994A describes a ship with recesses at the sides for vertically translating and stowing sail propulsion units.

Once again, this approach requires the ship to be specifically designed to accommodate these recesses.

### SUMMARY OF THE INVENTION

The aim of the present invention is to provide a simple, economical and reliable solution for reducing the space requirement or exposure of a rigid-wing or other type of sail propulsion unit on board a ship, particularly for loading and unloading operations at dockside and for marine navigation maneuvers when passing under a bridge. More particularly, the invention aims to take advantage of the existing structure of a ship, in particular the transverse bulkheads of the hull, of a merchant ship, in order to integrate in a particularly practical way stowage spaces for sail propulsion units in a non-use position.

For this purpose, a ship is proposed comprising at least one sail propulsion unit extending in a generally vertical direction in a position of use and comprising one or more propulsion elements and a mast, characterized in that the structure of the ship intrinsically comprises transverse structural elements defining at least in part at least one respective cavity for a sail propulsion unit, in that it comprises at least one sail propulsion unit situated generally above a cavity, and in that it further comprises a support for said sail propulsion unit, said support being movable in a generally vertical direction within the cavity, and drive means for selectively moving said support between a raised position of use and a retracted position of stowage.

This method optionally, comprises the following additional features, taken individually or in any combination that a person skilled in the art will understand as being technically compatible with one another:
in each cavity designed to receive a sail propulsion unit, the ship comprises a guide hoistway which closely receives said support and is generally vertically oriented.
the or each hoistway has a generally U-shaped cross-section with an opening wider than a width of the propulsion unit in a propulsion orientation adopted for its retraction.
limited-friction guide means are provided between each support and the associated hoistway.
each retractable propulsion unit has a large cross-sectional dimension and a small cross-sectional dimension, the ship further comprises a propulsion unit orientation control device to bring the propulsion unit into a retractable orientation allowing it to be retracted.
said retraction orientation is one wherein the large cross-sectional dimension of the propulsion unit is oriented transversely to a main axis of the ship.
said structural elements comprise pairs of structural panels extending both downwards and upwards relative to a deck of the ship, and delimit container loading spaces.
said structural elements comprise individual structural panels, and the ship comprises at least one add-on panel assembled to the ship structure to form with said individual structural panel a cavity for a sail propulsion unit.
the drive means comprise one or more cylinders for each support.
the drive means comprise one or more rack-and-pinion assemblies for each support.
for each support, the drive means comprise one or more suspension cables that can be wound onto a drum.

### BRIEF DESCRIPTION OF THE DRAWINGS

Other aspects, aims, and advantages of the present invention will become more apparent on reading the following detailed description of preferred embodiments thereof, given by way of non-limiting example and made with reference to the accompanying drawings, wherein:

FIG. 1 is an overall perspective view of a ship equipped with a series of mast-wing type sail propulsion systems,

FIG. 2 is a partial perspective view of a drive device of the propulsion unit,

FIG. 3 is a partial top view and partial horizontal cross-section of the device shown in FIG. 2,

FIGS. 4A and 4B are perspective views of the drive device shown in FIGS. 2 and 3, with FIG. 4A corresponding to FIG. 2,

FIGS. 5 and 6 are perspective views illustrating two alternative versions of a cavity accommodating the drive device, and

FIG. 7 is a partial perspective view along the ship's axis, showing two side-by-side drive devices.

### DETAILED DESCRIPTION OF AN EMBODIMENT

A structure and mechanisms will now be described that can be used on merchant marine ships to retract one or more sail propulsion units.

FIG. 1 illustrates a ship N, here of the container ship type, on deck P of which are mounted six movable sail propulsion units 100 according to the invention, in two rows of three propulsion units arranged along the port and starboard sides of the ship. The ship has a hull C, a deck P and a superstructure S, in a conventional manner per se.

Each propulsion unit here comprises two flaps 111, 112, the fore flap being traversed by a main mast 121 and the aft flap being traversed by a secondary mast 122, the two masts being connected at the bottom and top by a boom member 130 and a gaff member 140.

The main mast 121 protrudes below member 130 and forms the main support for the wing mast. The wing mast can be designed, for example, in accordance with the teachings of patent applications WO2018087649A1 and WO2020115717A1.

It can be seen that the ship N intrinsically has transverse structural elements T which extend downwards and upwards with respect to the deck P and which delimit, in pairs, spaces intended to receive stacks of containers CO of standardized dimensions, for example ISO standardized 20, 30 or 40 foot containers.

These structural elements T, also generally designated by reference 300, each consist of a pair of metal panels 301, 302 extending transversely to a main axis X of the ship, between the port and starboard sides of the hull, these panels being secured by welded connecting and stiffening elements, not shown. They themselves are welded to the hull.

In the vicinity of the hull, each pair of panels 301, 302 forms, on the one hand, with the corresponding hull side C (below deck P) and, on the other hand, with a side wall 311 (port) and 312 (starboard) respectively (above deck P), a cavity CA oriented vertically over a height which is determined on the one hand by the vertical extension of these structural elements 301, 302, 311, 312 above the deck (as shown in FIG. 1) and on the other hand by the vertical extension of the structural elements 301, 302 below the deck, typically down to the bilge.

According to one aspect of the invention and as shown in FIG. 1, at least some of these cavities CA, evenly distributed to port and starboard along the length of the ship, are associated with respective sail propulsion units 100, and each cavity CA can be used to retract the associated propulsion unit inside it into a position of stowage or non-use, by generally vertical movement of the propulsion unit.

The propulsion units can be retracted either when the ship is docked, to enable cargo loading/unloading operations, or in the event of excessive wind during navigation, or during navigation maneuvers when passing under a bridge.

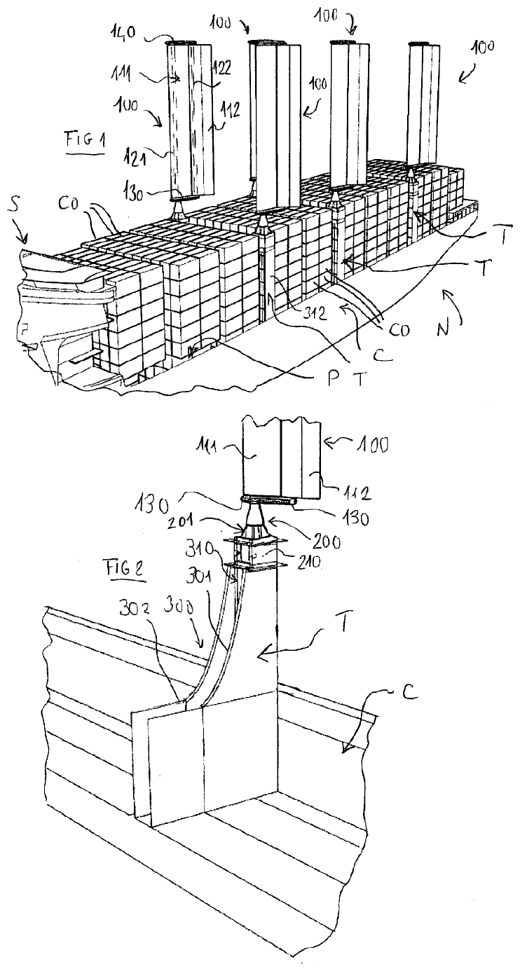

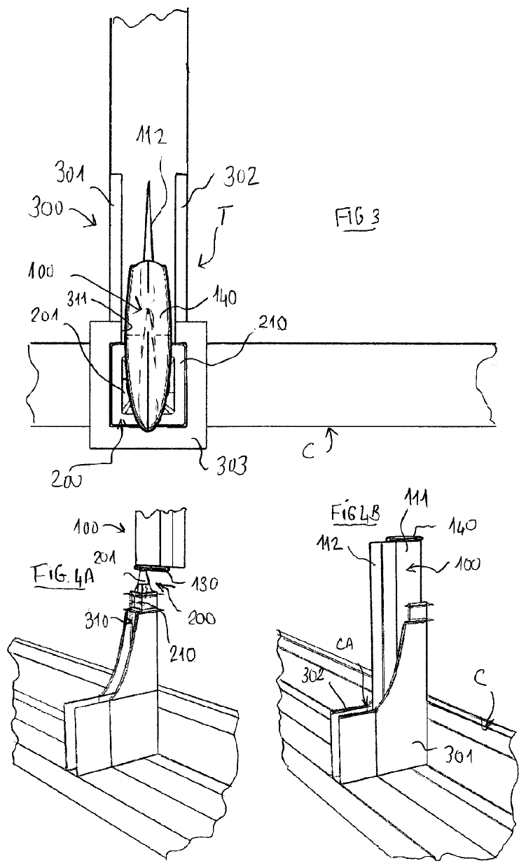

As shown in FIGS. 2 to 7, the base of the main mast 121 of a sail propulsion unit is rigidly attached to a drive device 200, which comprises a base 201 surmounted by the mast 121, and a mobile support 210 designed to move vertically in a hoistway 310 arranged in the associated cavity. As shown in FIG. 3, the hoistway has a generally U-shaped cross-section, so as to define on the one hand a housing which closely receives the mobile support 210, and on the other hand an opening 311 to accept the longitudinal extension of the sail propulsion unit 100 when oriented in the transverse direction of the ship.

It is advantageous to provide arrangements for guiding the support 210 in its hoistway 310 and/or limiting friction between these two elements during movement. These means may include a coating with a limited coefficient of friction, guide rollers or rollers, etc.

Different techniques can be envisaged for moving the support 210 and the propulsion unit it carries in its hoistway 310.

In a first embodiment, a cable mechanism may be provided comprising a drum onto which a cable is wound, the drum being driven by a motor such as an electric motor. The cable passes over a pulley at the top of the cavity CA, and the support 210 is suspended from the end of the cable opposite the drum. The number of cables can be multiplied according to the space available, the weight of the mobile equipment and the need to balance the suspension forces applied to the support 210.

In a second embodiment, a system can be provided comprising one or more hydraulic cylinders arranged vertically in the cavity CA and capable of exerting an upward thrust on the support and ensuring progressive descent of said support in the opposite direction.

In a third embodiment, a rack-and-pinion system can be used, with one or more racks mounted vertically in the cavity CA and cooperating with one or more homologous motorized pinions mounted on the support.

Although these means are not shown, the person skilled in the art will know how to implement them without any particular effort.

A travelling cable can be used to supply power to the drive motor(s) when mounted on the support 210.

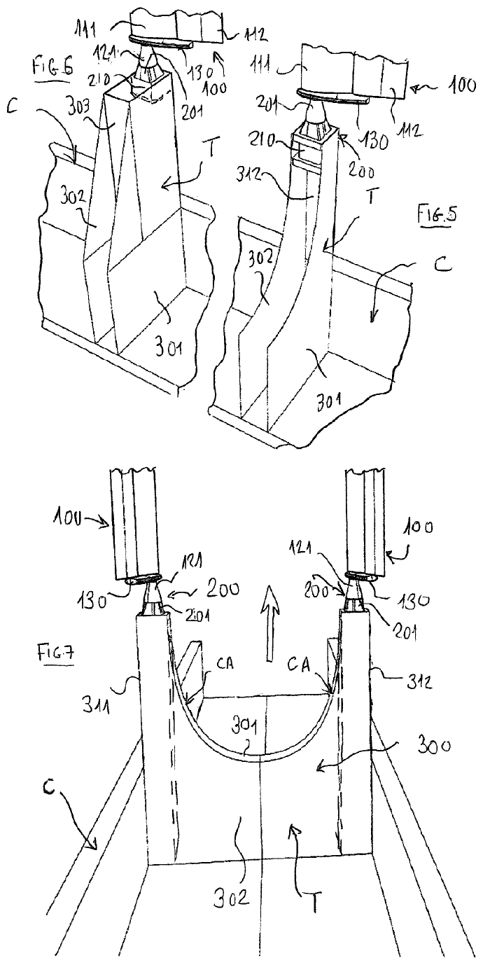

FIG. 4A is a partial view of a sail propulsion unit 100 in the position of use, with the support 210 in the raised position and the propulsion unit deployed above the respective through structure T, along the side of the ship.

To move from the position of FIG. 4A to the retracted position of FIG. 4B, the sail propulsion unit is first brought into an orientation generally aligned with the transverse direction of the ship, with its leading edge on the outboard side of the ship and its trailing edge on the inboard side, where its overall width (typically the width of the boom portion 130) is less than the width of the opening 311 of the generally U-shaped hoistway 310.

Once this position has been reached, the support 210 can be driven downwards by actuating the displacement means to move with it the sail propulsion unit 100, and bring it, or a substantial part of it, inside the cavity CA, as shown in FIG. 4B.

It is understood that the extent to which the propulsion unit 100 is retracted into the cavity depends on the height of the propulsion unit and the available height in the cavity CA, taking into account the space required for the movement control means.

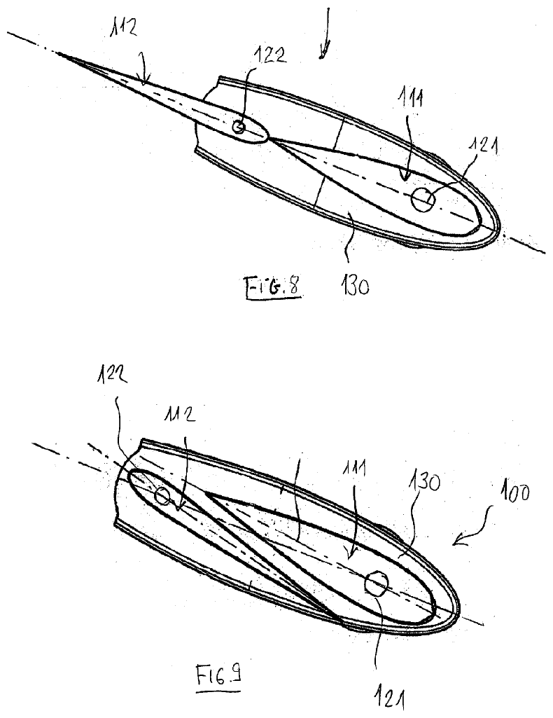

FIGS. 5 and 6 illustrate, by way of example, two possible embodiments of the T transverse structure. The embodiment shown in FIG. 5 (where hoistway 310 is not shown for simplicity) is substantially identical to that shown in FIGS. 2, 3, 4A-4B and 7, that is, cavity CA is open towards the central axis of the ship.

In the embodiment shown in FIG. 6, each cavity CA is closed on the inside by a panel 303 extending between panels 301 and 302, which also constitutes a structural element. The free dimension in the transverse direction of the cavity CA is then determined so as to accept the dimension of the sail propulsion unit 100 in this same direction in its retracted orientation.

According to an alternative embodiment, the ship is of the type comprising transverse panels not arranged in pairs, but individually. In this case, several approaches can be envisaged to create the cavity intended to receive a sail propulsion unit, and in particular:
on a ship having intrinsically individual panels, additional panels are installed over the entire width of the ship, at a predetermined distance from the pre-existing panels, in order to achieve the situation of the lower parts of the panels 301, 302 as described above;
in the vicinity of the ship's sides, partial complementary walls are added to the pre-existing individual panel, forming with an associated individual panel and the ship's side a closed or partially open cavity, suitable for receiving a respective sail propulsion unit.

Of course, the present invention is by no means limited to the embodiments described above and shown in the drawings, but the person skilled in the art will know how to make numerous variants or modifications.

In particular, the invention applies equally well to mast-wing or rigid-wing type propulsion units as to propulsion units based on different principles, such as Magnus effect rotors, suction rotors, etc.

1. A ship comprising at least one sail propulsion unit extending in a generally vertical direction in position of use and comprising one or more propulsion elements and a mast, the ship structure intrinsically comprising transverse structural elements defining at least in part at least one respective cavity, in that it comprises at least one sail propulsion unit situated generally above a cavity, and it further comprising a support for said sail propulsion unit, said support being movable in a generally vertical direction within the cavity, and a drive for selectively moving said support between a raised position of use and a retracted position of stowage.

2. The ship according to claim 1, comprising in each cavity intended to receive a sail propulsion unit, a guide hoistway closely receiving said support, and oriented generally vertically.

3. The ship according to claim 2, wherein the or each hoistway has a generally U-shaped cross-section with an opening of a width greater than a width of the sail propulsion unit in an orientation of the propulsion unit adopted for its retraction.

4. The ship according to claim 2, wherein a limited-friction guide is provided between each support and the associated hoistway.

5. The ship according to claim 1, wherein each sail propulsion unit has, in cross-section, a large dimension and a small dimension, and it further comprising a device for controlling the orientation of the sail propulsion unit to bring it into an orientation allowing it to be retracted.

6. The ship according to claim 5, wherein said retraction orientation is an orientation wherein the large dimension of the cross-section of the sail propulsion unit is oriented transversely to a main axis of the ship.

7. The ship according to claim 1, wherein said structural elements comprise pairs of structural panels extending both downwards and upwards with respect to a deck of the ship, and delimiting container loading spaces.

8. The ship according to claim 1, wherein said structural elements comprise individual structural panels, and comprising at least one added panel assembled to the ship structure to form with said individual structural panel a cavity for a sail propulsion unit.

9. The ship according to claim 1, wherein the drive comprises one or more cylinders for each support.

10. The ship according to claim 1, wherein the drive comprises one or more rack-and-pinion assemblies for each support.

11. The ship according to claim 1, wherein the drive comprises, for each support, one or more suspension cables which can be wound onto a drum.
